(19) United States
(12) Patent Application Publication
(10) Pub. No.: US 2026/0370000 A1
(43) Pub. Date: Nov. 19, 2026

(54) METHOD OF OPERATING HOUSEHOLD APPLIANCES BASED ON POWER AVAILABILITY

(71) Applicant: Haier US Appliance Solutions, Inc., Wilmington, DE (US)

(72) Inventors: Tyler Barton, Clarksville, IN (US); David Cambron, Louisville, KY (US); Nolan Polley, Ringgold, GA (US)

(21) Appl. No.: 19/209,876

(22) Filed: May 16, 2025

(51) Int. Cl. H02J 3/00; G05B 15/02

(52) U.S. Cl. CPC H02J 3/003; G05B 15/02

(57) ABSTRACT

A method of operating a household appliance includes determining an amount of power to be utilized for performing a selected cycle of the household appliance. Additionally, the method includes determining an available amount of power of a home power supply to which the household appliance is connected. Furthermore, the method includes comparing the determined amount of power to be utilized for performing the selected cycle to the determined available amount of power of the home power supply. Moreover, the method includes modifying the selected cycle in response to the determined amount of power to be utilized for performing the selected cycle exceeding the determined available amount of power of the home power supply. Additionally, the method includes operating the household appliance according to the modified selected cycle.

### FIELD

The present subject matter relates generally to household appliances with features for responding to the availability of power for supplying to the household appliances.

### BACKGROUND

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Such appliances use electrical components while accomplishing domestic tasks, such as a motor to rotate a basket or drum of a laundry appliance, a heater or heating element to increase the temperature of water (in appliances such as a water heater appliance, a washing machine appliance, or a dishwashing appliance) or of air (e.g., in an air conditioning appliance or dryer appliance), or a pump or compressor to urge or motivate a fluid through or within the household appliance, among other similar components and operations.

In some instances, the availability of the power for supplying the household appliances may be reduced or otherwise limited. The electrical components in one or more household appliances, such as the exemplary components mentioned above, or other electrical components utilized during selected cycles of the household appliances, may utilize significant quantities of power from the power supply. As such, the quantities of power necessary for normal operation of the household appliances for the selected cycles may not be available.

Accordingly, there exists a need for household appliances with features for identifying and responding to (e.g., compensating for or adjusting to) limited availability of power.

### BRIEF DESCRIPTION

Aspects and advantages of the invention will be set forth in part in the following description, or may be obvious from the description, or may be learned through practice of the invention.

In accordance with one embodiment of the present disclosure, a method of operating a household appliance is provided. The method includes determining an amount of power to be utilized for performing a selected cycle of the household appliance. Additionally, the method includes determining an available amount of power of a home power supply to which the household appliance is connected. Furthermore, the method includes comparing the determined amount of power to be utilized for performing the selected cycle to the determined available amount of power of the home power supply. Moreover, the method includes modifying the selected cycle in response to the determined amount of power to be utilized for performing the selected cycle exceeding the determined available amount of power of the home power supply. Additionally, the method includes operating the household appliance according to the modified selected cycle.

In accordance with another embodiment of the present disclosure, a household appliance is provided. The household appliance includes a controller. The controller is configured for determining an amount of power to be utilized for performing a selected cycle of the household appliance. Additionally, the controller is configured for determining an available amount of power of a home power supply to which the household appliance is connected. Furthermore, the controller is configured for comparing the determined amount of power to be utilized for performing the selected cycle to the determined available amount of power of the home power supply. Moreover, the controller is configured for modifying the selected cycle in response to the determined amount of power to be utilized for performing the selected cycle exceeding the determined available amount of power of the home power supply. Additionally, the controller is configured for operating the household appliance according to the modified selected cycle.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a front view of a dishwashing appliance in accordance with additional embodiments of the present disclosure.

FIG. 5 provides a transverse cross-sectional view of the dishwashing appliance of FIG. 4.

FIG. 6 provides a perspective view of an oven appliance according to one or more exemplary embodiments of the present subject matter.

FIG. 7 provides a transverse cross-sectional view of the oven appliance of FIG. 6 taken along line 2-2 of FIG. 6.

FIG. 8 provides a schematic diagram of a household appliance in communication with a home power management system device and a remote database according to one or more embodiments of the present disclosure.

FIG. 9 provides a flowchart illustrating an example method of operating a household appliance according to one or more embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

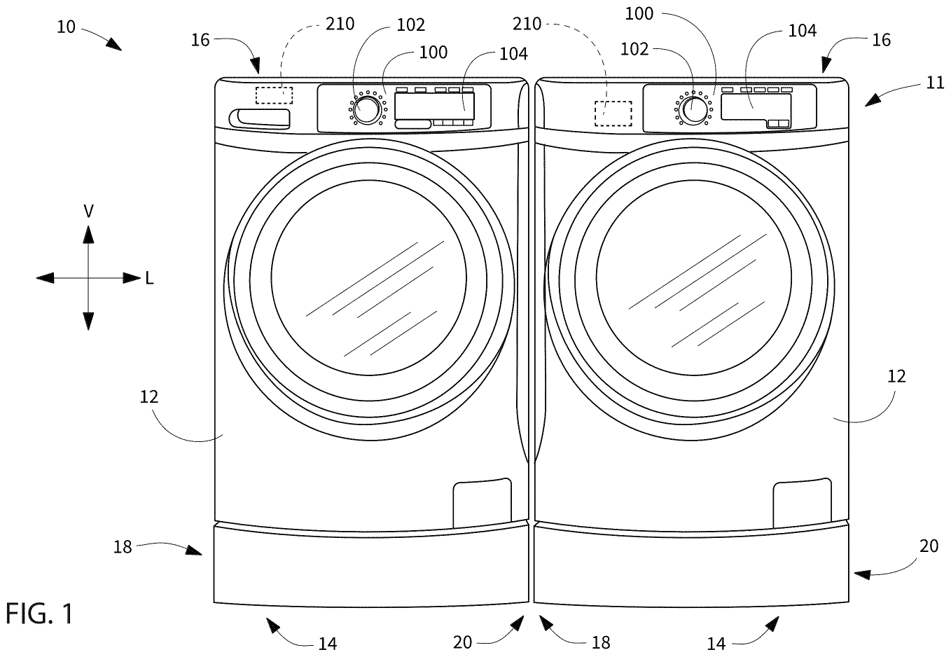

As may be seen in FIGS. 1 through 7, in accordance with one or more embodiments of the present subject matter, a household appliance is provided. Specific examples of such household appliances are each described in turn below to illustrate various aspects and embodiments of the present disclosure. However, it should be understood that such examples are non-limiting and the household appliance of the present disclosure may include a variety of appliances with various features operable to perform household and/or domestic tasks.

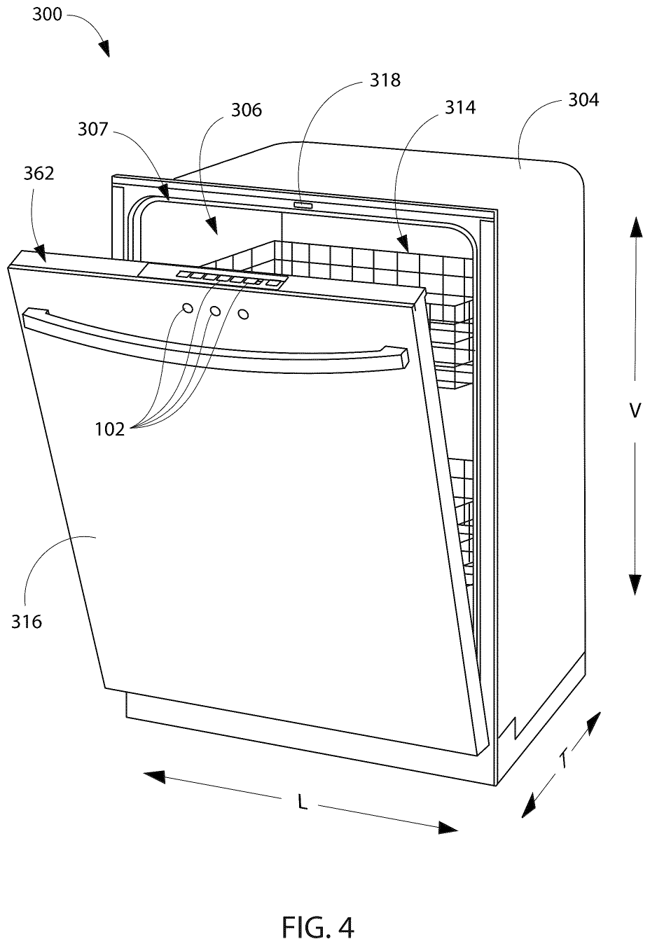

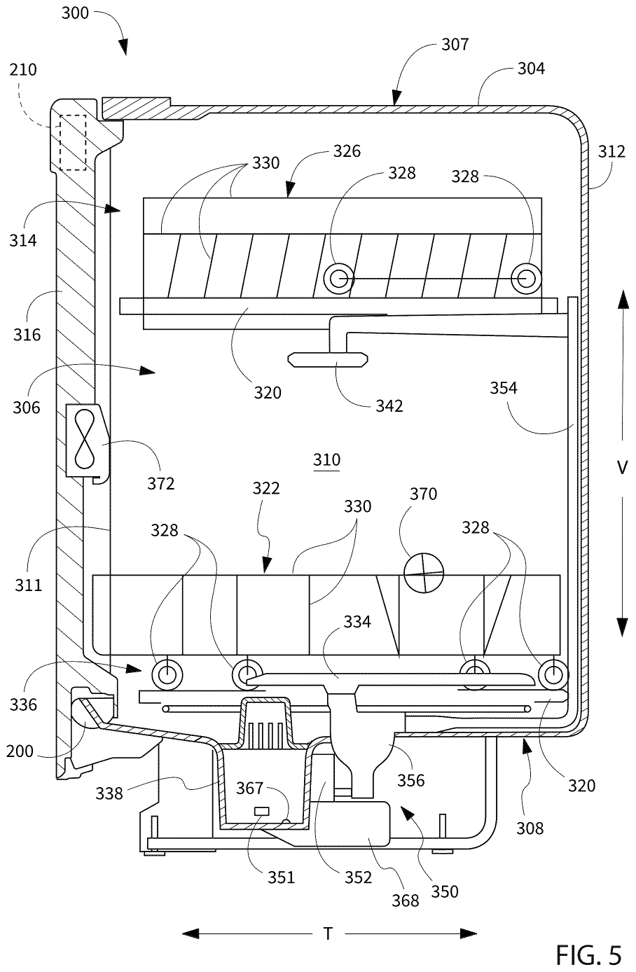

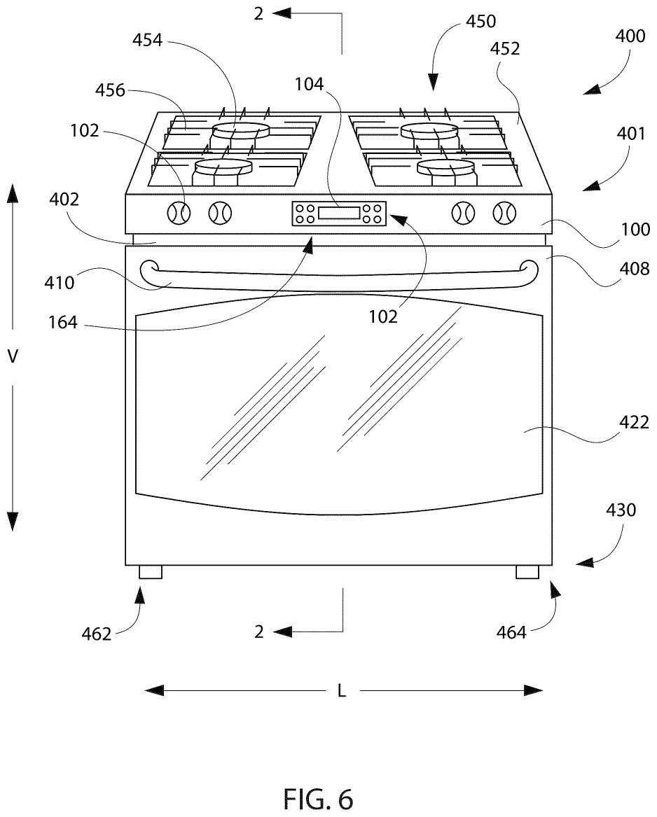

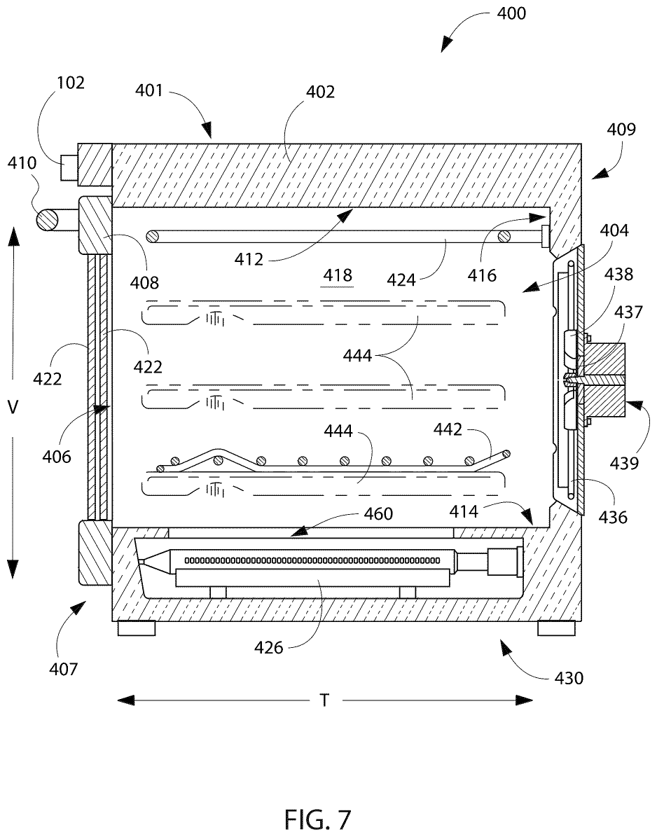

It should be understood that “household appliance” and/or “appliance” are used herein to describe appliances typically used or intended for common domestic tasks, such as a laundry appliance, e.g., as illustrated in FIGS. 1 through 3, or a dishwashing appliance (see, e.g., FIGS. 4 and 5), an oven appliance (see, e.g., FIGS. 6 and 7), a refrigerator, a water heater, etc., and any other household appliance which performs similar functions in addition to network communication and data processing. Accordingly, it will be recognized that the domestic task(s) which the appliance is configured to perform includes operating on tangible matter (e.g., water, air, food items, laundry articles, and/or other such matter) to change a physical attribute (e.g., temperature, pressure, position, velocity, etc.) of the tangible matter using a mechanical component of the appliance. Thus, devices such as personal computers, routers, and other similar devices, the primary functions of which are network communication and/or data processing, are not considered household appliances as used herein.

As may be seen generally throughout FIGS. 1 through 7, a user interface panel 100 and a user input device 102 may be positioned on an exterior of the appliance. The user input device 102 is generally positioned proximate to the user interface panel 100 and, in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical, or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, the appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance may be regulated by the controller 210 that is operatively coupled to the user interface panel 100. A user interface panel 100 may for example provide selections for user manipulation of the operation of an appliance, e.g., via user input device 102 and/or display component 104. In response to user manipulation of the user interface panel 100 and/or user input device 102, the controller 210 may operate various components of the appliance. Controller 210 may include a memory and one or more microprocessors, CPUs, or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that, when executed by the processing device, cause the processing device to perform operations. Controller 210 may include one or more processor(s) and associated memory device(s) configured to perform a variety of computer-implemented functions and/or instructions (e.g., performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, either appliance or both appliances of a pair of laundry appliances 10 and 11 may be the household appliance. In embodiments such as illustrated in FIG. 1, the user input device 102 of each household appliance 10 and 11 may be positioned on the user interface panel 100. The embodiment illustrated in FIG. 1 also includes a display component 104 on the user interface panel 100 of each household appliance 10 and 11.

As generally seen throughout FIGS. 1 through 3, each household appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

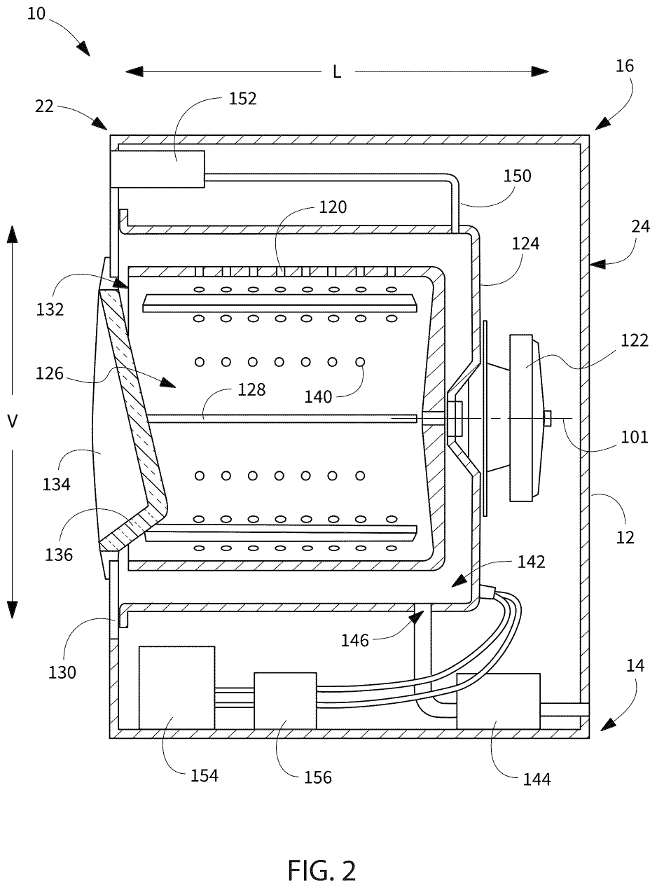

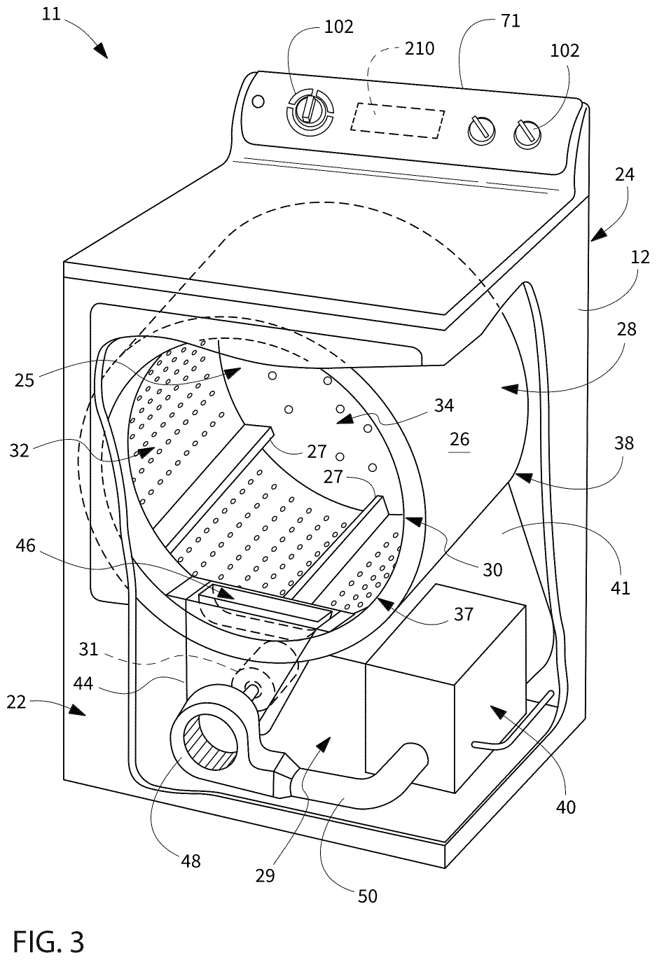

Additional exemplary details of the laundry appliances are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the wash tub 124 such that the wash basket 120 is rotatable about an axis of rotation, which generally coincides with central axis 101 of the wash tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the wash tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from wash basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of wash basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from wash basket 120 to sump 142 through plurality of perforations 140. A pump assembly 144 is located beneath wash tub 124 for gravity assisted flow when draining wash tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a dispenser drawer 152 is slidably mounted within front panel 130. Dispenser drawer 152 receives a wash additive (e.g., detergent, fabric softener, bleach, or any other suitable liquid or powder) and directs the fluid additive to wash tub 124 during operation of washing machine appliance 10. According to the illustrated embodiment, dispenser drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user may fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, laundry items are loaded into wash basket 120 through opening 132, and washing operation is initiated through operator manipulation of input selectors 102. Wash tub 124 is filled with water, detergent, and/or other fluid additives, e.g., via spout 150 and/or dispenser drawer 152. One or more valves (not shown) may be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 may be agitated (e.g., with ribs 128) for washing of laundry items in wash basket 120.

After the agitation phase of the wash cycle is completed, wash tub 124 may be drained. Laundry articles may then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, wash basket 120 is rotated at relatively high speeds. After articles disposed in wash basket 120 are cleaned and/or washed, the user may remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a household appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then permit such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 may be fixed or may be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by supply duct 41. After the clothing articles have been dried, they are removed from the drum 26 via opening 32. A door (FIG. 1) provides for closing or accessing drum 26 through opening 32.

In some embodiments, one or more input selectors 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower fan 48, or heating system 40. In turn, signals generated in controller 210 direct operation of motor 31, blower fan 48, or heating system 40 in response to the position of selector inputs 102. As used herein, “processing device” or “controller” may refer to one or more microprocessors, microcontrollers, application-specific integrated circuits (ASICS), or semiconductor devices and is not restricted necessarily to a single element. The controller 210 may be programmed to operate dryer appliance 11 by executing instructions stored in memory (e.g., non-transitory media). The controller 210 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

Turning now to FIGS. 4 and 5, in some embodiments, the household appliance may be a dishwasher or dishwashing appliance, such as the exemplary dishwashing appliance 300, that may be configured in accordance with aspects of the present disclosure. Generally, dishwashing appliance 300 defines a vertical direction V, a lateral direction L, and a transverse direction T. Each of the vertical direction V, lateral direction L, and transverse direction T are mutually perpendicular to one another and form an orthogonal direction system.

Dishwashing appliance 300 includes a tub 304 that defines a wash chamber 306 therein. As shown in FIG. 5, tub 304 extends between a top 307 and a bottom 308 along the vertical direction V, between a pair of side walls 310 along the lateral direction L, and between a front side 311 and a rear side 312 along the transverse direction T.

Tub 304 includes a front opening 314 at the front side 311. In some embodiments, the dishwashing appliance 300 may also include a door 316 at the front opening 314. The door 316 may, for example, be coupled to the tub 304 by a hinge 200 at its bottom for movement between a normally closed vertical position (FIG. 5), wherein the wash chamber 306 is sealed shut for washing operation, and a horizontal open position (not shown, while a partially open position is illustrated in FIG. 4) for loading and unloading of articles from dishwashing appliance 300. A door closure mechanism or assembly 318, e.g., a latch, may be provided to lock and unlock door 316 for accessing and sealing wash chamber 306.

In exemplary embodiments, the pair of side walls 310 accommodate a plurality of rack assemblies. For instance, guide rails 320 may be mounted to the pair of side walls 310 for supporting a lower rack assembly 322 and an upper rack assembly 326. In some such embodiments, upper rack assembly 326 is positioned at a top portion of wash chamber 306 above lower rack assembly 322 along the vertical direction V.

Generally, each rack assembly 322, 326 may be adapted for movement between an extended loading position (not shown) in which the rack is substantially positioned outside the wash chamber 306, and a retracted position (shown in FIG. 5) in which the rack is located inside the wash chamber 306. In some embodiments, movement is facilitated, for instance, by rollers 328 mounted onto rack assemblies 322, 326, respectively.

Although guide rails 320 and rollers 328 are illustrated herein as facilitating movement of the respective rack assemblies 322, 326, it should be appreciated that any suitable sliding mechanism or member may be used according to alternative embodiments.

In optional embodiments, some or all of the rack assemblies 322, 326 are fabricated into lattice structures including a plurality of wires or elongated members 330 (for clarity of illustration, not all elongated members making up rack assemblies 322, 326 are shown). In this regard, rack assemblies 322, 326 are generally configured for supporting articles within wash chamber 306 while permitting a flow of wash liquid to reach and impinge on those articles (e.g., during a cleaning or rinsing cycle). According to additional or alternative embodiments, a silverware basket (not shown) may be removably attached to a rack assembly (e.g., lower rack assembly 322), for placement of silverware, utensils, and the like, which are otherwise too small to be accommodated by the rack assembly.

Generally, dishwashing appliance 300 includes one or more spray assemblies for urging a flow of fluid (e.g., wash liquid) onto the articles placed within wash chamber 306. In exemplary embodiments, dishwashing appliance 300 includes a lower spray arm assembly 334 disposed in a lower region 336 of wash chamber 306 and above a sump 338 so as to rotate in relatively close proximity to lower rack assembly 322. In this regard, lower spray arm assembly 334 may generally be configured for urging a flow of wash liquid up through lower rack assembly 322.

In some embodiments, an upper spray assembly 342 may be located proximate to and, e.g., below, upper rack assembly 326 along the vertical direction V. In this manner, upper spray assembly 342 may be generally configured for urging of wash liquid up through upper rack assembly 326.

The various spray assemblies and manifolds described herein may be part of a fluid distribution system or fluid circulation assembly 350 for circulating wash liquid in tub 304. In certain embodiments, fluid circulation assembly 350 includes a circulation pump 352 for circulating wash liquid in tub 304. Circulation pump 352 may be mounted to sump 338 and in fluid communication with the sump 338 through a circulation outlet 351 from the sump 338.

When assembled, circulation pump 352 may be in fluid communication with an external water supply line (not shown) and sump 338. A water inlet valve (not shown) may be positioned between the external water supply line and circulation pump 352 (e.g., to selectively permit water to flow from the external water supply line to circulation pump 352). Additionally, or alternatively, water inlet valve may be positioned between the external water supply line and sump 338 (e.g., to selectively permit water to flow from the external water supply line to sump 338). During use, water inlet valve may be selectively controlled to open to permit the flow of water into dishwashing appliance 300 and may be selectively controlled to close and thereby cease the flow of water into dishwashing appliance 300. Further, fluid circulation assembly 350 may include one or more fluid conduits or circulation piping for directing wash fluid from circulation pump 352 to the various spray assemblies and manifolds. In exemplary embodiments, such as that shown in FIG. 5, a primary supply conduit 354 extends from circulation pump 352, along rear side 312 of tub 304 along the vertical direction V to supply wash liquid throughout wash chamber 306.

In optional embodiments, circulation pump 352 urges or pumps wash liquid to a diverter 356 (FIG. 5). In some such embodiments, diverter 356 is positioned within sump 338 of dishwashing appliance 300. Diverter 356 may include a diverter disk (not shown) disposed within a diverter chamber (not shown) for selectively distributing the wash liquid to the spray assemblies 334, 342, or other spray manifolds or assemblies. For instance, the diverter disk may have at least one aperture configured to align with one or more outlet ports (not shown) at the top of the diverter chamber. In this manner, the diverter disk may be selectively rotated to provide wash liquid to the desired spray device(s).

In exemplary embodiments, diverter 356 is configured for selectively distributing the flow of wash liquid from circulation pump 352 to various fluid supply conduits—only some of which are illustrated in FIG. 5 for clarity. In certain embodiments, diverter 356 includes two or more outlet ports (not shown) for supplying wash liquid to a first conduit for rotating lower spray arm assembly 334 and a second conduit for supplying upper spray assembly 342 (e.g., primary supply conduit 354). Additional embodiments may also include one or more additional conduits, e.g., a third conduit for spraying an auxiliary rack such as a silverware rack, etc.

In some embodiments, primary supply conduit 354 is used to supply wash liquid to one or more spray assemblies (e.g., to upper spray assembly 342). It should be appreciated, however, that according to alternative embodiments, any other suitable plumbing configuration may be used to supply wash liquid throughout the various spray manifolds and assemblies described herein. For instance, according to another exemplary embodiment, primary supply conduit 354 may be used to provide wash liquid to lower spray arm assembly 334 and a dedicated secondary supply conduit (not shown) may be utilized to provide wash liquid to upper spray assembly 342. Other plumbing configurations may be used for providing wash liquid to the various spray devices and manifolds at any location within dishwashing appliance 300.

Each spray assembly 334 and 342, or other spray device as may be included in dishwashing appliance 300, may include an arrangement of discharge ports or orifices for directing wash liquid received from circulation pump 352 onto dishes or other articles located in wash chamber 306. The arrangement of the discharge ports, also referred to as jets, apertures, or orifices, may provide a rotational force by virtue of wash liquid flowing through the discharge ports. Alternatively, spray assemblies 334, 342 may be motor-driven, or may operate using any other suitable drive mechanism. Spray manifolds and assemblies may also be stationary. The resultant movement of the spray assemblies 334, 342 and the spray from fixed manifolds provides coverage of dishes and other dishwasher contents with a washing spray. Other configurations of spray assemblies may be used as well. For instance, dishwashing appliance 300 may have additional spray assemblies for cleaning silverware, for scouring casserole dishes, for spraying pots and pans, for cleaning bottles, etc.

Drainage of soiled wash liquid within sump 338 may be provided, for instance, by a drain pump 368 (e.g., during or as part of a drain cycle). In particular, wash liquid may exit sump 338 through a drain outlet 367 and may flow through a drain conduit or directly to the drain pump 368. Thus, drain pump 368 is downstream of sump 338 and facilitates drainage of the soiled wash liquid by urging or pumping the wash liquid to a drain line external to dishwashing appliance 300.

In some embodiments, a filter assembly may be provided, e.g., in the sump 338 and/or at a top entrance into the sump 338, e.g., to filter fluid to fluid circulation assembly 350 and/or drain pump 368. Generally, the filter assembly removes soiled particles from the liquid that flows to the sump 338 from the wash chamber 306 during operation of dishwashing appliance 300. In exemplary embodiments, the filter assembly may include both a first filter (also referred to as a “coarse filter”) and a second filter (also referred to as a “fine filter”).

Although a separate circulation pump 352 and drain pump 368 are described herein, it is understood that other suitable pump configurations (e.g., using only a single pump for both recirculation and draining) may be provided.

Dishwashing appliance 300 may also include ventilation features, e.g., to promote improved, e.g., more rapid, drying of articles therein after the wash and rinse cycles. For example, one or more vents 370 may be provided in the tub 304 for introducing relatively dry air from outside of the tub 304 into the wash chamber 306 and/or for removing relatively humid air from the wash chamber 306 to the outside of the tub 304. In some embodiments, a fan 372 may be provided. The fan 372 may be operable to urge air through the wash chamber 306, such as to promote air circulation and/or ventilation within and through the wash chamber 306. Such air movement may increase the rate of evaporation of moisture from articles in the wash chamber 306 after a wash and/or rinse cycle.

In certain embodiments, dishwashing appliance 300 includes a controller 210 configured to regulate operation of dishwashing appliance 300 (e.g., initiate one or more wash operations). Controller 210 may include one or more memory devices and one or more microprocessors, etc., as described above. It should be noted that controllers as disclosed herein are capable of and may be operable to perform any methods and associated method steps as disclosed herein.

Controller 210 may be positioned in a variety of locations throughout dishwashing appliance 300. In optional embodiments, controller 210 is located within a control panel area 362 of door 316 (e.g., as shown in FIG. 4). Input/output (“I/O”) signals may be routed between the control system and various operational components of dishwashing appliance 300 along wiring harnesses that may be routed through the bottom of door 316. Typically, the controller 210 includes or is operatively coupled to a user input device/controls 102 through which a user may select various operational features and modes and monitor progress of dishwashing appliance 300. In some embodiments, the user interface includes a general purpose I/O (“GPIO”) device or functional block. In additional or alternative embodiments, user interface includes input components, such as one or more of a variety of electrical, mechanical or electro-mechanical input devices including rotary dials, push buttons, and touch pads. In further additional or alternative embodiments, the user interface may include a display component, such as a digital or analog display device designed to provide operational feedback to a user. When assembled, the user interface may be in operative communication with the controller 210 via one or more signal lines or shared communication busses.

It should be appreciated that the invention is not limited to any particular style, model, or configuration of dishwashing appliance 300. The exemplary embodiments depicted in FIGS. 4 and 5 are for illustrative purposes only. For instance, different locations may be provided for user input devices 102, different configurations may be provided for rack assemblies 322, 326, different spray assemblies 334, 342 and spray manifold configurations may be used, different sensors may be used, and other differences may be applied while remaining within the scope of the present disclosure.

FIGS. 6 and 7 illustrate another exemplary household appliance, which in this example is an oven appliance 400 according to an exemplary embodiment of the present subject matter. Oven appliance 400 includes an insulated cabinet 402 which defines a vertical direction V, a lateral direction L, and a transverse direction T. The vertical, lateral, and transverse directions V, L, and T are mutually perpendicular and form an orthogonal direction system. Cabinet 402 extends between a top portion 401 and a bottom portion 430 along the vertical direction V. Cabinet 402 extends between a left side 462 and a right side 464 along the lateral direction L and between a front portion 407 and a back portion 409 along the transverse direction T.

As shown in FIG. 6, oven appliance 400 includes a cooktop 450. Cooktop 450 is disposed on and is attached to or integral with cabinet 402. Cooktop 450 includes a top panel 452, which by way of example may be constructed of glass, ceramics, enameled steel, or combinations thereof. One or more burners 454 extend through top panel 452. A utensil (e.g., pots, pans, etc.) holding food and/or cooking liquids (e.g., oil, water, etc.) may be placed onto grates 456 disposed adjacent burners 454. Burners 454 provide thermal energy to cooking utensils placed on grates 456. Each burner 454 may be any suitable type of burner, including e.g., gas, electric, electromagnetic, a combination of the foregoing, etc. It will be appreciated that the configuration of cooktop 450 is provided by way of example only and that other suitable configurations are contemplated.

Still referring to FIGS. 6 and 7, for this exemplary embodiment, oven appliance 400 includes an insulated cabinet 402 with an interior cooking chamber 404 defined by a top wall 412, a floor or bottom wall 414, a back wall 416, and a pair of opposing side walls 418. Cooking chamber 404 is configured for the receipt of one or more food items to be cooked. Oven appliance 400 includes a door 408 pivotally mounted to cabinet 402 at the opening 406 of cabinet 402 to permit selective access to cooking chamber 404 through opening 406. A handle 410 is mounted to door 408 and assists a user with opening and closing door 408. For example, a user may pull on handle 410 to open or close door 408 and access cooking chamber 404.

Oven appliance 400 may include a seal (not shown) between door 408 and cabinet 402 that assists with maintaining heat and cooking vapors within cooking chamber 404 when door 408 is closed as shown in FIGS. 6 and 7. Multiple parallel glass panes 422 provide for viewing the contents of cooking chamber 404 when door 408 is closed and assist with insulating cooking chamber 404. A baking rack 442 is positioned in cooking chamber 404 for the receipt of food items or utensils containing food items. Baking rack 442 is slidably received onto embossed ribs or sliding rails 444 such that baking rack 442 may be conveniently moved into and out of cooking chamber 404 when door 408 is open.

One or more heating elements may be included at the top, bottom, or both of cooking chamber 404 to provide heat to cooking chamber 404 for cooking. Such a heating element(s) may be gas, electric, microwave, or a combination thereof. For example, in the embodiment shown in FIG. 7, oven appliance 400 includes a top heating element 424 which, in the illustrated example embodiment is an electric resistance heating element 424, and a bake heating element or bottom heating element 426, which, in the illustrated example embodiment is a gas burner 426, and bottom heating element 426 is positioned adjacent to and below bottom wall 414.

Also, as may be seen in FIG. 7, the gas burner 426 is positioned within the cabinet 402 and outside of the cooking chamber 404. In some embodiments, for example as illustrated in FIG. 7, the gas burner 426 may be a bake heating element or bottom heating element and may be positioned below the cooking chamber 404 and separated from the cooking chamber 404 by a partition, e.g., the bottom wall 414 of the cooking chamber 404. The gas burner 426 may be in thermal communication and in fluid communication with the chamber by a flow path extending through one or more apertures or openings 460 in the bottom wall 414. In at least some embodiments, the flow path may extend from the gas burner 426, e.g., from ports thereof, through the opening(s) 460, and into the cooking chamber 404.

In the illustrated example embodiment, oven appliance 400 also has a convection heating element 436 and convection fan 438 positioned adjacent back wall 416 of cooking chamber 404. Convection fan 438 is powered by a convection fan motor 439. Further, convection fan 438 may be a variable speed fan—meaning the speed of fan 438 may be controlled or set anywhere between and including, e.g., zero and one hundred percent (0%-100%). In certain embodiments, oven appliance 400 may also include a bidirectional triode thyristor (not shown), i.e., a triode for alternating current (TRIAC), to regulate the operation of convection fan 438 such that the speed of convection fan 438 may be adjusted during operation of oven appliance 400. The speed of convection fan 438 may be determined by controller 210 (not specifically illustrated in FIGS. 6 and 7, but which is similar to the controllers 210 described above). In addition, a sensor 437 such as, e.g., a rotary encoder, a Hall effect sensor, or the like, may be included at the base of convection fan 438, for example, between convection fan 438 and convection fan motor 439 as shown in the exemplary embodiment of FIG. 7, to sense the speed of convection fan 438. The speed of convection fan 438 may be measured in, e.g., revolutions per minute (RPM). In some embodiments, the convection fan 438 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity. Additionally, the convection heating features are optional and are shown and described herein solely by way of example. In other embodiments the oven appliance 400 may include different convection heating features or may not include convection heating features at all.

In various embodiments, more than one convection heater, e.g., more than one convection heating elements 436 and/or convection fans 438, may be provided. In such embodiments, the number of convection fans and convection heaters may be the same or may differ, e.g., more than one convection heating element 436 may be associated with a single convection fan 438. Similarly, more than one top heating element 424 and/or more than one bottom heating element 426 may be provided in various combinations, e.g., one top heating element 424 with two or more bottom heating elements 426, two or more bottom heating elements 426 with no top heating element 424, etc.

Oven appliance 400 also includes a user interface 164 having a display component 104 positioned on a user interface panel 100 and having a variety of controls 102. User interface 164 permits the user to select various options for the operation of oven appliance 400 including, e.g., various cooking and cleaning cycles. Operation of oven appliance 400 may be regulated by a controller 210 that is operatively coupled to, i.e., in communication with, user interface 164, heating elements 424, 426, and other components of oven appliance 400 as will be further described. In some embodiments, display component 104 may also be used as an input device. For instance, in such embodiments, display component 104 may be a touchscreen device. In some embodiments, display component 104 is the only input device on user interface 164, e.g., the controls 102 may be omitted and the input functionality may be provided by the display component 104, which may be a touchscreen device.

For example, in response to user manipulation of the user interface 164, the controller may operate the heating element(s). The controller may receive measurements from one or more temperature sensors (not shown) which are in or in thermal communication with the cooking chamber 404. The controller may also provide information such as a status indicator, e.g., a temperature indication, to the user with display component 104.

Although shown with touch type controls, it should be understood that controls 102 and the configuration of oven appliance 400 shown in FIGS. 6 and 7 is provided by way of example only. More specifically, user interface 164 may include various input components, such as one or more of a variety of electrical, mechanical, or electro-mechanical input devices including rotary dials, push buttons, and touch pads. User interface 164 may include other display components, such as a digital or analog display device designed to provide operational feedback to a user. User interface 164 may be in communication with the controller via one or more signal lines or shared communication busses.

The present invention may also be used with other cooking appliances such as, e.g., a wall oven, a stand-alone oven, a cooktop, or other configurations of such cooking appliances. Numerous variations in the oven configuration are possible within the scope of the present subject matter. For example, variations in the type and/or layout of the controls 102 on the user interface 164, as mentioned above, are possible. As another example, the oven appliance 400 may include multiple doors 408 instead of or in addition to the single door 408 illustrated. Such examples include a dual cavity oven, a French door oven, and others. As still another example, one or more of the illustrated heating elements may be substituted with microwave heating elements, or any other suitable heating elements. The examples described herein are provided by way of illustration only and without limitation.

According to various embodiments of the present disclosure, a household appliance may take the form of any of the examples described above or may be any other household appliance. Thus, it will be understood that the present subject matter is not limited to any particular household appliance.

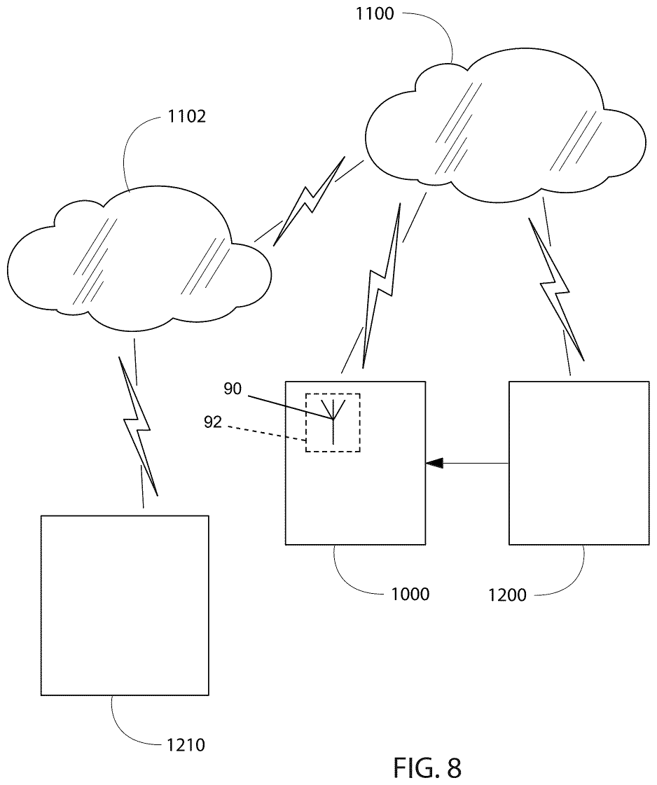

Turning now to FIG. 8, a general schematic of a household appliance 1000, including communication features thereof, is provided. FIG. 8 schematically illustrates a household appliance 1000, a home power supply 1200, a first cloud 1100, a second cloud 1102, and a home power management system 1210, all of which are interconnected with each other, directly or indirectly, for communication between and among each of the foregoing devices. This communication may be achieved using any suitable communication protocols and interfaces, such as one or more wireless networks, to transfer useful information or data. For example, the interconnected devices may share consumer usage data, user preferences, appliance operating parameters, operating conditions, and/or other useful data or information. Sharing data between and among various appliances or other devices within the system, e.g., the exemplary system illustrated in FIG. 8, may result in improved overall system operation, including improved efficiency and performance of each appliance or other device individually and/or all appliances and other devices collectively.

The illustrated household appliance 1000 may be, for example, one of the laundry appliances 10 or 11 of FIGS. 1 through 3, the dishwashing appliance 300 of FIGS. 4 and 5, or the oven appliance 400 of FIGS. 6 and 7, among other possible example household appliances.

The first cloud 1100 and second cloud 1102 each may be any suitable remote computing system or environment, such as one or more remote computing devices with which the household appliance 1000 communicates wirelessly and over a network, such as the internet. For example, each cloud 1100 and 1102 may be or may include a cloud-based data storage system including any suitable number, type, and configuration of remote computing devices such as remote databases, remote servers, network devices, and/or other external devices that are able to communicate with each other or are otherwise interconnected, which may be collectively referred to as a “cloud,” or other similar distributed computing environment, e.g., “fog,” or “edge.” For example, the household appliance 1000 may communicate with the first cloud 1100 and/or second cloud 1102 over the internet, which the household appliance 1000 may access via WI-FI®, such as from a WI-FI® access point in a user's home.

The home power management system 1210 may be any suitable device, e.g., which includes a controller (where the controller of the home power management system 1210 may be constructed in the same or similar manner as the controller 210 of the household appliance as described hereinabove), for managing the energy/power usage in the household. For example, the home power management system 1210 may be a dedicated device, or energy management features (e.g., software) may be provided in a multipurpose device, such as a personal computer, smartphone, smart home system, and/or other similar devices which include a controller and are operable to store and run software applications (also known as “apps’).

The home power management system 1210 may provide centralized monitoring and management of energy consumption within the home, e.g., the home power management system 1210 may be communicatively coupled with, or otherwise connected to, one or more household appliances, e.g., household appliance 1000, and the home power supply 1200. The home power management system 1210 may thereby know the status of the home power supply 1200 and may direct activation of loads. For example, the home power management system 1210 may direct when and how many loads, e.g., household appliances, turn ON and draw power from the home power supply 1200. The home power management system 1210 may be provided as a separate, stand alone, local device (e.g., in the home) as illustrated in FIG. 8, or may be integrated into another device (such as the home power supply 1200, or another multipurpose device, as noted above), or may be implemented remotely, e.g., in the cloud. As used herein, the “home,” e.g., in which the household appliance 1000 and home power supply 1200 are located and for which energy is managed by the home power management system 1210, may be any residential structure or dwelling, such as a single-family home, multi-family home, or other similar settings.

As illustrated in FIG. 8, the household appliance 1000 may include an antenna 90 by which the household appliance 1000 communicates with, e.g., sends and receives signals to and from, one or both of the first cloud 1100 and the second cloud 1102. The antenna 90 may be part of, e.g., onboard, a communications module 92. The communications module 92 may be a wireless communications module operable to connect wirelessly, e.g., over the air, to one or more other devices via any suitable wireless communication protocol. For example, the communications module 92 may be a WI-FI® module, a BLUETOOTH® module, or a combination module providing both WI-FI® and BLUETOOTH® connectivity. The communications module 92 may be onboard the controller 210 or may be a separate module.

The household appliance 1000 and home power supply 1200 may be in communication with the home power management system 1210 through various possible communication connections and interfaces. The household appliance 1000, home power supply 1200, and the home power management system 1210 may be matched in wireless communication, e.g., connected to the same wireless network. The household appliance 1000 and the home power supply 1200 may communicate with the home power management system 1210 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 1000, the home power supply 1200, and the home power management system 1210. For example, BLUETOOTH® Low Energy may advantageously minimize the power consumed by the exemplary methods and devices described herein due to the low power networking protocol of BLUETOOTH® Low Energy. Additionally, and as schematically represented in FIG. 8, the household appliance 1000 and the home power supply 1200 may be connected in communication with the home power management system 1210 indirectly (e.g., via a single cloud or other network, or via multiple networks, such as via cloud-to-cloud communication as illustrated in FIG. 8).

As illustrated in FIG. 8, the household appliance 1000 may be electrically coupled to the home power supply 1200, e.g., whereby the home power supply 1200 may supply power to the household appliance 1000 (as indicated by the arrow in FIG. 8). The home power supply 1200 may be or include a locally renewable or replenishable power source, such as a solar panel, battery, generator, and/or other similar devices.

Also as illustrated in FIG. 8, the household appliance 1000 and the home power supply 1200 may both be in communication with the home power management system 1210, such that the home power management system 1210 may monitor the status of the household appliance 1000 and the home power supply 1200 and the home power management system 1210 may send commands to one or both of the household appliance 1000 and the home power supply 1200. For example, the household appliance 1000 may be in communication with an appliance cloud (e.g., owned and/or operated by the manufacturer of the household appliance 1000), such as the first cloud 1100 may be the appliance cloud, while the home power management system 1210 may be in communication with an energy management cloud (e.g., owned and/or operated by the manufacturer of the home power management system 1210), such as the second cloud 1102 may be the energy management cloud, and the clouds may be in communication with each other, e.g., as illustrated in FIG. 8, such that the household appliance 1000 is in communication with the home power management system 1210 via cloud-to-cloud communication as mentioned above. In additional embodiments, the household appliance 1000 and the home power management system 1210 may both be in communication with the same cloud, e.g., only one cloud (or other network) may be used in the exemplary energy management systems and methods disclosed herein.

Exemplary methods for operating a household appliance, such as but not limited to one or more of the laundry appliances 10 or 11 of FIGS. 1 through 3, the dishwashing appliance 300 of FIGS. 4 and 5, and/or the oven appliance 400 of FIGS. 6 and 7, among other possible example household appliances, are provided. In this regard, for example, a controller of the household appliance, e.g., controller 210, and/or an external controller, e.g., of a home power management system 1210 or a remote device in the cloud, may be configured for implementing some or all steps of one or more of the following exemplary methods. It should be appreciated, however, that the exemplary methods are discussed herein only to describe exemplary aspects of the present subject matter and are not intended to be limiting.

Now that the construction of exemplary household appliances and the configuration of controller 210 according to exemplary embodiments have been presented, exemplary methods of operating a household appliance will be described. In exemplary embodiments, the various method steps as disclosed herein may be performed locally, e.g., by controller 210 and/or a separate, dedicated controller integrated into the household appliance. Furthermore, some or all of the various method steps may be performed remotely, e.g., in a distributed computing environment such as the cloud, fog, or edge, wherein the controller 210 communicates with one or more remote computing devices of the distributed computing environment, such as data processing and/or analysis, may be performed in the cloud and the output of such process may be transmitted to and received by the household appliance 1000, such as by the controller 210 thereof via the communications module 92.

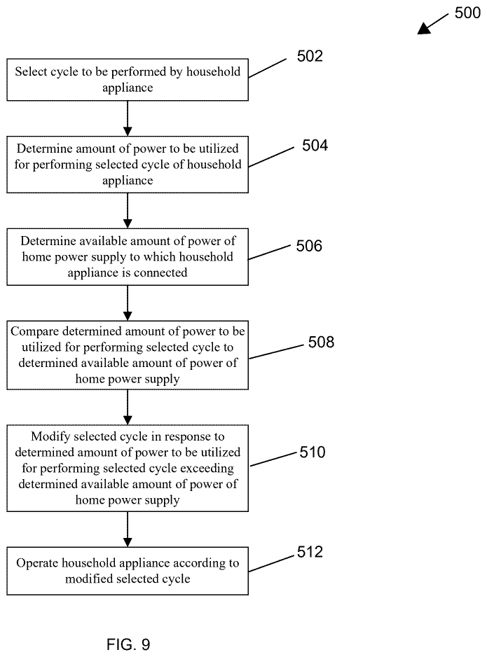

As illustrated in FIG. 9, embodiments of the present disclosure also include methods of operating a household appliance, where the household appliance may be any one or more of the foregoing exemplary appliances, e.g., laundry appliance 10 or 11, dishwashing appliance 300, and/or oven appliance 400, described above. Further, methods of operating a household appliance according to the present disclosure are not necessarily limited to the exemplary appliances described or illustrated. For example, when the household appliances is a cooking appliance, the cooking appliance may include various combinations of heating modules and/or heating elements as in any of the foregoing examples, such as an oven appliance with only electric radiant heating (e.g., without convection), an oven appliance with gas bake heating element and convection heating, an oven appliance with ceramic heating modules and heat lamps, among numerous other possible combinations.

Exemplary methods according to the present subject matter include method 500 of operating a household appliance illustrated in FIG. 9. As illustrated in FIG. 9, the method 500 includes selecting a cycle to be performed by the household appliance, e.g., as indicated at (502) in FIG. 9. Specifically, a user of the household appliance may select a cycle, e.g., by user input device 102, touchscreen of display component 104, or a remote user interface device, to be performed by the household appliance. For example, the cycle may be a first cycle, such as a heated tumble dry cycle of the dryer appliance 11. However, it should be appreciated that the selected cycle may be any other suitable cycle of a dryer appliance or of any other suitable household appliance, such as one of the household appliances described herein.

Additionally, the method 500 includes determining an amount of power to be utilized for performing a selected cycle of the household appliance, e.g., as indicated at (504) in FIG. 9. Specifically, a controller, e.g., the controller 210 of the household appliance, a controller of a remote user interface device, a controller of a cloud, or a controller of the home power management system 1210, may determine the amount of power to be utilized for performing the cycle of the household appliance selected at (502). For example, the amount of power, e.g., power values or quantities, for each selectable cycle of the household appliance may be stored within the memory of the controller, e.g., the controller 210 of the household appliance. As such, after the cycle has been selected at (502), the controller may correlate the selected cycle with a specific power quantity or a range of power quantities for the selected cycle that are stored within the memory of the controller.

Furthermore, the method 500 includes determining an available amount of power of a home power supply to which the household appliance is connected, e.g., as indicated at (506) in FIG. 9. Specifically, a controller, e.g., the controller 210 of the household appliance, a controller of a remote user interface device, a controller of a cloud, or a controller of the home power management system 1210, the available amount of power of the home power supply 1200 which, as described above, is connected to the household appliance. For example, in some embodiments, the home power management system 1210 may be directly coupled to the home power supply 1200 and may monitor the power availability of the home power supply 1200. Additionally, as described above, the controller 210 of the household appliance may be communicatively connected or coupled to the home power management system 1210. As such, when determining the amount of power to be utilized for performing the selected cycle of the household appliance, the controller 210 of the household appliance may receive an input from the home power management system 1210 that is indicative of the available amount of power/remaining power of the home power supply 1200. Thereafter, the controller 210 of the household appliance may determine the available amount of power of the home power supply 1200 based on the input received from the home power management system 1210. As described above, in some embodiments, the home power supply 1200 may be or may include a renewable power source, e.g., solar panel, battery, generator, and/or other similar devices. As such, the controller, e.g., the controller 210 of the household appliance, may determine the available or remaining amount of power of the renewable power source. As described herein, the amount of power may be a remaining amount of power before depletion of power, such as depletion of power of the renewable power source prior to replenishment of the power of the power source by receiving sunlight, recharging, and/or the like. The amount of power may be measured in one or more unit types, such as watts, amps, voltage, and/or the like.

In some embodiments, prior to determining the available amount of power of the home power supply, the method 500 may include determining that the household appliance is communicatively coupled to the home power management system. Specifically, the controller, e.g., the controller 210, the controller of the home power management system 1210, the controller of a remote user interface device, and/or a controller of a cloud, may determine that the household appliance is communicatively coupled to the home power management system 1210. For example, the controller 210 of the household appliance may query a local WI-FI® network to obtain a list of devices that are connected to the local WI-FI® network. The controller 210 may determine that the household appliance and the home power management system 1210 are connected via WI-FI® when determined that the household appliance and the home power management system 1210 are both included in the list of devices.

Moreover, the method 500 includes comparing the determined amount of power to be utilized for performing the selected cycle to the determined available amount of power of the home power supply, e.g., as indicated at (508) in FIG. 9. Specifically, the controller, e.g., the controller 210, the controller of the home power management system 1210, the controller of a remote user interface device, and/or a controller of a cloud, may compare the amount of power to be utilized for performing the selected cycle determined at (504) to the available amount of power of the home power supply 1200 determined at (506). As will be described below, the controller may proceed with performing the selected cycle, modify the selected cycle of the household appliance, or not proceed with performing any cycle of the household appliance based on comparing the determined amount of power to be utilized for performing the selected cycle to the determined available amount of power of the home power supply 1200.

Additionally, the method 500 includes modifying the selected cycle in response to the determined amount of power to be utilized for performing the selected cycle exceeding the determined available amount of power of the home power supply, e.g., as indicated at (510) in FIG. 9. Specifically, the controller, e.g., the controller 210, the controller of the home power management system 1210, the controller of a remote user interface device, and/or a controller of a cloud, may modify or change the selected cycle in response to the amount of power to be utilized for performing the selected cycle determined at (504) exceeding the available amount of power of the home power supply 1200 determined at (506). In some embodiments, prior to modifying the cycle selected at (502), which may be a first cycle, the controller may determine that a second cycle different from the first cycle may be available for selection. An amount of power to be utilized for performing the second cycle may be equal to or less than the available amount of power of the home power supply 1200 determined at (506). As such, the amount of power to be utilized for performing the second cycle may be less than the amount of power to be utilized for performing the first cycle. For example, the first cycle/cycle selected at (502), may be a high heat tumble dry cycle and the second cycle may be a low heat tumble dry cycle. The high heat tumble dry cycle may utilize more heat than the low heat tumble dry cycle. In this respect, the heating element of the heating system 40 may be active to emit more heat for the high heat tumble dry cycle than the low heat tumble dry cycle and, thus, more power is utilized for the high heat tumble dry cycle.

Additionally, in some embodiments, prior to modifying the cycle selected at (502), the controller may determine that a low-power version of the first cycle/cycle selected at (502) may be available for selection. An amount of power to be utilized for performing the low-power version of the first cycle may be equal to or less than the available amount of power of the home power supply 1200 determined at (506). For example, the first cycle may utilize a first electrical component, e.g., motor 31, and a second electrical component, e.g., heating element of the heating system 40, different from the first electrical component. In some embodiments, only the first electrical component, e.g., motor 31, may be active or utilized during the low-power version of the first cycle while the second electrical component, e.g., the heating element of the heating system 40, is inactive or not utilized. As such, during operation of the household appliance, e.g., dryer appliance 11, during the low-power version of the first cycle, clothes within the dryer appliance 11 may be tumbled without heat applied. Additionally, or alternatively, in some embodiments, one or both of the first electrical component and the second electrical component may be throttled or operated at a lower power output relative to the cycle selected at (502) during the low-power version of the first cycle. Furthermore, in some embodiments, a cycle or runtime of the low-power version of the first cycle may be lesser than a cycle or runtime of the cycle selected at (502). As such, the household appliance may operate at a lesser cycle or runtime than the cycle selected at (502) when operated at the low-power version of the first cycle.

In some embodiments, modifying the selected cycle may include selecting one of the second cycle or the low-power version of the first cycle. For example, the controller, e.g., the controller 210, the controller of the home power management system 1210, the controller of a remote user interface device, and/or a controller of a cloud, may provide a prompt to a user of the household appliance to select one of the second cycle or the low-power version of the first cycle. In this respect, the user is permitted to select one of the second cycle or the low-power version of the first cycle. For example, in some embodiments, the controller may provide the prompt on a display, such as the display component 104, e.g., touchscreen. Thus, the user may select either the second cycle or the low-power version of the first cycle from the provided prompt. As such, the selected first cycle may be modifying according to the user selection from the provided prompt. However, it should be appreciated that, while described herein as provided to the user for selection, in some other embodiments, the selected first cycle may be modified automatically, e.g., without user input, by the controller, e.g., the controller 210, the controller of the home power management system 1210, the controller of a remote user interface device, and/or a controller of a cloud, such as based on some predetermined criteria stored within the memory of the controller. For example, the controller may select from the second cycle and the low-power version of the first cycle according to which of the two cycles utilizes less power or according to which is most similar to the original user selected cycle. Thereafter, as will be described below, the household appliance may operate according to the modified selected cycle. However, in some other embodiments, when the controller determines that the determined amount of power to be utilized for performing the selected first cycle is equal to or less than the determined available amount of power of the home power supply 1200, the selected first cycle may not be modified. As such, the household appliance may operate according the selected first cycle.

Moreover, the method 500 may include operating the household appliance according to the modified selected cycle, e.g., as indicated at (512) in FIG. 9. Specifically, the controller, e.g., the controller 210, the controller of the home power management system 1210, the controller of a remote user interface device, and/or a controller of a cloud, may operate the household appliance according to the selected first cycle as modified at (510). For example, in some embodiments, when the low-power version of the first cycle is selected, the controller may activate the first electrical component, e.g., motor 31, and not activate the second electrical component, e.g., heating element of heating system 40.

Referring again to FIG. 9, method steps are depicted in a particular order for purposes of illustration and discussion. Those of ordinary skill in the art, using the disclosures provided herein, will understand that (except as otherwise indicated) the steps of method 500 can be modified, adapted, rearranged, omitted, interchanged, or expanded in various ways without deviating from the scope of the present disclosure. Thus, those of ordinary skill in the art will recognize that the various steps of the exemplary methods described herein may be combined in various ways to arrive at additional embodiments within the scope of the present disclosure.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a household appliance, the method comprising:
determining an amount of power to be utilized for performing a selected cycle of the household appliance;
determining an available amount of power of a home power supply to which the household appliance is connected;
comparing the determined amount of power to be utilized for performing the selected cycle to the determined available amount of power of the home power supply;
modifying the selected cycle in response to the determined amount of power to be utilized for performing the selected cycle exceeding the determined available amount of power of the home power supply; and
operating the household appliance according to the modified selected cycle.

2. The method of claim 1, wherein the selected cycle is a selected first cycle, wherein modifying the selected first cycle of the household appliance comprises:
selecting a second cycle different from the selected first cycle, an amount of power to be utilized for performing the selected second cycle less than the determined amount of power to be utilized for performing the selected first cycle and equal to or less than the available amount of power of the home power supply.

3. The method of claim 1, wherein modifying the selected cycle of the household appliance comprises:
selecting a low-power version of the selected cycle, an amount of power to be utilized for performing the selected low-power version of the selected cycle less than the determined amount of power to be utilized for performing the selected cycle and equal to or less than the available amount of power of the home power supply.

4. The method of claim 3, wherein operating the household appliance according to the modified selected cycle comprises:
operating the household appliance according to the selected low-power version of the selected cycle, whereby a first electrical component of the household appliance is active and a second electrical component of the household appliance is inactive.

5. The method of claim 3, wherein operating the household appliance according to the modified selected cycle comprises:
operating the household appliance according to the selected low-power version of the selected cycle, whereby an electrical component of the household appliance is operated at a lower power output than the selected cycle.

6. The method of claim 3, wherein operating the household appliance according to the modified selected cycle comprises:
operating the household appliance according to the selected low-power version of the selected cycle, whereby the household appliance operates for a lesser cycle time than the selected cycle.

7. The method of claim 1, further comprising:
prior to determining the available amount of power of the home power supply, determining that the household appliance is communicatively connected to a home power management system.

8. The method of claim 7, wherein determining that the household appliance is communicatively connected to the home power management system comprises:
determining that the household appliance and the home power management system are connected to a local WI-FI network.

9. The method of claim 1, wherein determining the available amount of power of the home power supply comprises:
receiving, by a controller of the household appliance, an input from a home power management system indicative of the available amount of power of the home power supply; and
determining, by the controller of the household appliance, the available amount of power of the home power supply based on the received input from the home power management system.

10. The method of claim 1, wherein the selected cycle is a selected first cycle, the method further comprising:
prior to modifying the selected first cycle, determining that a second cycle different from the selected first cycle is available for selection, wherein an amount of power to be utilized for performing the second cycle is less than the determined amount of power to be utilized for performing the selected first cycle and equal to or less than the available amount of power of the home power supply;
prior to modifying the selected first cycle, determining that a low-power version of the selected first cycle is available for selection, wherein an amount of power to be utilized for performing the low-power version of the selected first cycle is less than the determined amount of power to be utilized for performing the selected first cycle and equal to or less than the available amount of power of the home power supply; and
providing a prompt to a user of the household appliance in response to the determined amount of power to be utilized for performing the selected first cycle exceeding the determined available mount of power of the home power supply, whereby the user is permitted to select one of the second cycle or the low-power version of the selected first cycle,
wherein, modifying the selected first cycle comprises modifying the selected first cycle according to a user selection from the provided prompt.

11. A household appliance, comprising:
a controller, the controller configured for:
determining an amount of power to be utilized for performing a selected cycle of the household appliance;
determining an available amount of power of a home power supply to which the household appliance is connected;
comparing the determined amount of power to be utilized for performing the selected cycle to the determined available amount of power of the home power supply;
modifying the selected cycle in response to the determined amount of power to be utilized for performing the selected cycle exceeding the determined available amount of power of the home power supply; and
operating the household appliance according to the modified selected cycle.

12. The household appliance of claim 11, wherein the selected cycle is a selected first cycle, wherein modifying the selected first cycle of the household appliance comprises:
selecting a second cycle different from the selected first cycle, an amount of power to be utilized for performing the selected second cycle less than the determined amount of power to be utilized for performing the selected first cycle and equal to or less than the available amount of power of the home power supply.

13. The household appliance of claim 11, wherein modifying the selected cycle of the household appliance comprises:
selecting a low-power version of the selected cycle, an amount of power to be utilized for performing the selected low-power version of the selected cycle less than the determined amount of power to be utilized for performing the selected cycle and equal to or less than the available amount of power of the home power supply.

14. The household appliance of claim 13, further comprising:
a first electrical component; and
a second electrical component different from the first electrical component,
wherein, operating the household appliance according to the modified selected cycle comprises operating the household appliance according to the selected low-power version of the selected cycle, whereby the first electrical component is active and the second electrical component is inactive.

15. The household appliance of claim 11, wherein the controller is further configured for:
prior to determining the available amount of power of the home power supply, determining that the household appliance is communicatively connected to a home power management system.

16. The household appliance of claim 15, wherein determining that the household appliance is communicatively connected to the home power management system comprises:
determining that the household appliance and the home power management system are connected to a local WI-FI network.

17. The household appliance of claim 11, wherein determining the available amount of power of the home power supply comprises:
receiving an input from a home power management system indicative of the available amount of power of the home power supply; and
determining the available amount of power of the home power supply based on the received input from the home power management system.

18. The household appliance of claim 11, wherein the selected cycle is a selected first cycle, the controller further configured for:
prior to modifying the selected first cycle, determining that a second cycle different from the selected first cycle is available for selection, wherein an amount of power to be utilized for performing the second cycle is less than the determined amount of power to be utilized for performing the selected first cycle and equal to or less than the available amount of power of the home power supply;
prior to modifying the selected first cycle, determining that a low-power version of the selected first cycle is available for selection, wherein an amount of power to be utilized for performing the low-power version of the selected first cycle is less than the determined amount of power to be utilized for performing the selected first cycle and equal to or less than the available amount of power of the home power supply; and
providing a prompt to a user of the household appliance in response to the determined amount of power to be utilized for performing the selected first cycle exceeding the determined available mount of power of the home power supply, whereby the user is permitted to select one of the second cycle or the low-power version of the selected first cycle,
wherein, modifying the selected first cycle comprises modifying the selected first cycle according to a user selection from the provided prompt.

19. The household appliance of claim 11, wherein:
the home power supply comprises a renewable power source to which the household appliance is connected; and
determining the available amount of power of the home power supply comprises determining an available amount of power of the renewable power source.
